(19) United States
(12) Patent Application Publication
(10) Pub. No.: US 2003/0009559 A1
(43) Pub. Date: Jan. 9, 2003

(54) Network system and method of distributing accesses to a plurality of server apparatus in the network system

(76) Inventor: Naoya Ikeda, Yokohama (JP)

Correspondence Address: MATTINGLY, STANGER & MALUR, P.C., ATTORNEYS AT LAW, 1800 DIAGONAL ROAD, SUITE 370, ALEXANDRIA, VA, 22314, US

(21) Appl. No.: 10/189,468

(22) Filed: Jul. 8, 2002

(30) Foreign Application Priority Data
Jul. 9, 2001 (JP) 2001-208181

(51) Int. Cl. G06F 15/173

(52) U.S. Cl. 709/225; 709/105

(57) ABSTRACT

A network system includes a plurality of servers, a plurality of load balancing apparatus and at least one routing apparatus. Each load balancing apparatus is connected to two or more servers of a plurality of servers. Each routing apparatus is connected to two or more load balancing apparatus of a plurality of load balancing apparatus and to a network. Each routing apparatus receives an access packet for a plurality of server apparatus from the network and forwards the access packet so received to an arbitrary one of the two or more load balancing apparatus connected to the routing apparatus. Each load balancing apparatus receives an access packet from each routing apparatus and transfers it to an arbitrary server among the two or more servers connected thereto.

### BACKGROUND OF THE INVENTION

This invention relates to a load balancing method. More particularly, this invention relates to a load balancing method that makes it possible to distribute accesses to a plurality of Web servers of an information service site having one domain name (host name) through an Internet, or the like.

Recently, a variety of Internet services including EC (electronic commerce) have been drastically increasing in addition to utilization of Web accesses. Also, a phenomenon occurs in which traffic to a Web server of a specific site providing an information service sporadically increases. Therefore, providers providing the Internet services such as data centers and ASP (Application Service Providers) are required to provide services at a higher speed with higher reliability. A technology for distributing a traffic load to a specific site is known as a technology that can secure reliability and safety of the Web system.

In the technology of this kind, sites having the same domain name and providing the same service have a plurality of Web servers. The technology distributes the accesses to this site to a plurality of servers by using a load balancing apparatus and a DNS (Domain Name System) server. Incidentally, the DNS server is a server that converts the domain name designated from a client to a corresponding IP (Internet Protocol) address. Such a technology is disclosed in JP-A-2001-117897 and JP-A-2000-132524, for example.

Another technology uses the load balancing apparatus in combination with the DNS server. In this technology, a plurality of load balancing apparatus is provided to a plurality of Web servers of sites executing the same service. A route to each load balancing apparatus is selected on the basis of the IP address notified from the DNS server to the client.

### SUMMARY OF THE INVENTION

According to the former technology, the load balancing apparatus can uniformly distribute the accesses (traffics) from the client, and has therefore the advance that it can avoid a bottleneck and can reduce the traffic load. However, the function of the load balancing apparatus itself has become higher and higher in recent years and the function itself has got diversified. Therefore, when the number of Web servers to which the load is to be distributed becomes great, the load balancing apparatus fails to exhibit sufficient performance.

The latter technology can switch the route to one load balancing apparatus to the route of another by using the DNS server when any fault occurs in the route to one load balancing apparatus. However, this technology needs a switching time of dozens of seconds (approximately 40 seconds) from detection of the fault to switching of the routes, and is not free from the problem that high-speed performance and high reliability get deteriorated.

This invention provides a load balancing method that solves the problems of the prior art technologies described above, can reduce the load to the load balancing apparatus to the Web server inside the site and can switch at a high speed the route even when any fault occurs in the route to one load balancing apparatus.

According to the invention, a network system includes a plurality of servers, a plurality of load balancing apparatus and at least one routing apparatus. Each load balancing apparatus is connected to two or more servers among a plurality of servers. Each routing apparatus is connected to two or more load balancing apparatus among a plurality of load balancing apparatus and is also connected to a network. Each routing apparatus receives an access packet from the network to a plurality of servers and forwards the access packet so received to an arbitrary load balancing apparatus among the two or load balancing apparatus connected to the routing apparatus. Each load balancing apparatus receives the access packet from each routing apparatus and transfers it to an arbitrary server among the two or more servers connected thereto.

In this network system, each routing apparatus forwards and distributes a plurality of access packets received from the network system to a plurality of load balancing apparatus. Each load balancing apparatus distributes and transfers a plurality of access packets forwarded to each load balancing apparatus to a plurality of servers.

### BRIEF DESCRIPTION OF THE DRAWINGS

FIG. 1 shows a construction of a network system according to Embodiment 1 of the invention;

FIG. 2 shows a concrete example of setting of addresses in each apparatus;

FIG. 3 shows another concrete example of the network system; and

FIG. 4 shows a mode of fragmentation of an IPv4 packet.

### DESCRIPTION OF THE EMBODIMENTS

Embodiments of the invention will be explained in detail with reference to the accompanying drawings.

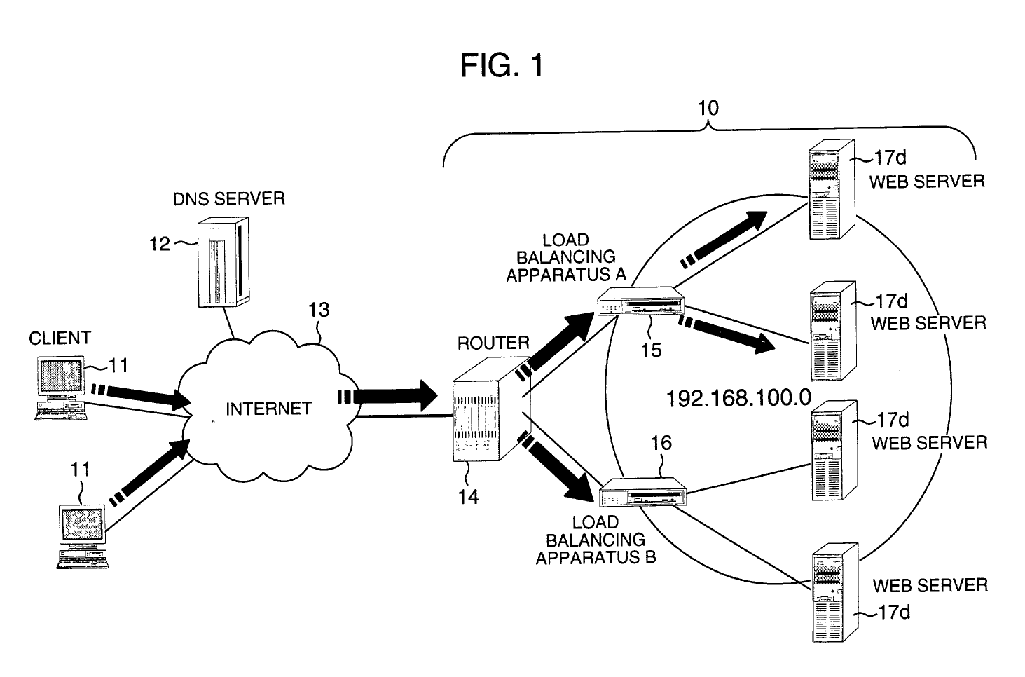

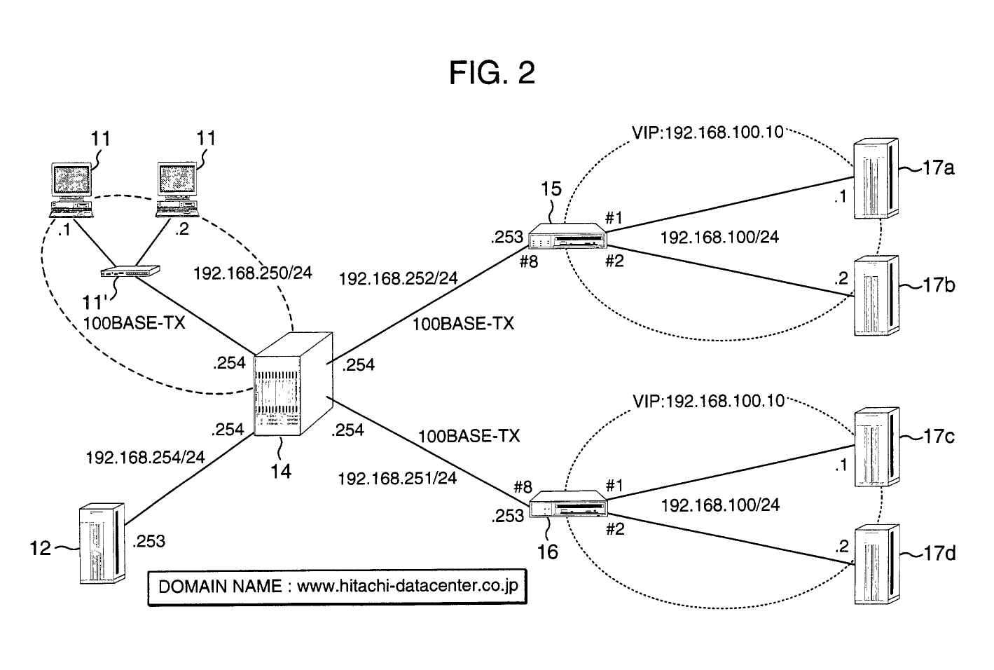

FIG. 1 shows an overall construction of a network according to Embodiment 1. FIG. 2 shows a concrete example of setting of addresses in each apparatus.

As shown in FIG. 1, the network according to Embodiment 1 includes a plurality of client terminals 11, a DNS server 12, a site 10 and a network such as the Internet 13 to which these constituent apparatus are connected. A personal computer PC for receiving an information service, or the like, constitutes each client terminal 11. The client terminal 11 issues an access (packet) to the site 10. The DNS server 12 converts a domain name (host name) transmitted by the client terminal 11 for receiving the information service of the site 11 to an IP address of a Web server inside the site 10 and outputs this IP address.

The site 10 has a network system for executing the information service. The network system of the site 10 includes a router 14, load balancing apparatus A15 and B16 and a plurality of Web servers 17a to 17d. The router 14 establishes connection with the Internet 13. The router 14 receives the access issued from the client terminal 11 from the Internet 13 and transfers the access to the load balancing apparatus A15 and B16. The load balancing apparatus A15 and B16 execute load balancing of the access transferred from the router 14 to a plurality of Web servers. These Web servers 17a to 17d are respectively connected to the load balancing apparatus A15 and B16. All of them have the same construction and execute the same information service.

Incidentally, FIG. 1 shows two load balancing apparatus connected to the router and two Web servers connected to each load balancing apparatus. However, the number of the load balancing apparatus connected to the router and the number of Web servers connected to each load balancing apparatus may be greater than two.

In the network system having the construction described above, when two or more different routes exist to the same destination (specific network and server in this case), the router 14 has the function of distributing and transferring the access (packet) to the destination through each route. When the apparatus to which the access is to be next transferred (here, the router and the load balancing apparatus) is different for each route, the router 14 can distribute the access to each apparatus of the transfer destination due to this function. In FIG. 1, for example, the same virtual IP address “192.168.100.10” is set to the Web servers 17a to 17d. Therefore, the router 14 recognizes the Web servers 17a to 17d as the same destination. In this case, there are a route passing through the load balancing apparatus A15 and a route passing through the load balancing apparatus B16 between the router 14 and the Web servers 17a to 17d. Therefore, due to the function described above, the router 14 can dispersedly transfer the access to the Web servers 17a to 17d to the load balancing apparatus A15 and to the load balancing apparatus B16 through the respective routes. According to this function, further, the router 14 calculates a hash value from the address information contained in the access received in accordance with a certain hash function. The router 14 associates in advance each load balancing apparatus with each has value. The router 14 transfers the access it receives to the load balancing apparatus with which the calculated hash value is associated.

Each of the load balancing apparatus A15, B16 has a virtual LAN function and allocates the access to each Web server 17a, 17b and 17c, 17d by round robin scheduling.

In consequence, the network system of the site 10 can uniformly allocate a large number of accesses inputted to the router 14 to the Web servers 17a to 17d. Eventually, the site 10 can cope with a sporadic increase of the traffic and can continue the service without deteriorating high-speed performance and high reliability. When any fault develops between the router and the load balancing apparatus, hardware processing by the router can instantaneously switch the route to the other load balancing apparatus side.

Next, a concrete example of address setting to each apparatus and its operation example will be explained with reference to FIG. 2.

The network construction shown in FIG. 2 is fundamentally the same as the construction shown in FIG. 1. However, two client terminals 11 are connected to a hub 11′. The hub 11′ is connected to the router 14 through the Internet not shown in the drawing. In this FIG. 2, a domain name of the site 10 is www.hitachi-datacenter.co.jp. A network address of the network between the load balancing apparatus A15 and the router 14 is “192.168.252/24”. A host address of an interface on the router 14 side of the load balancing apparatus AlS is “253”. Therefore, an IP address of an interface on the side of the load balancing apparatus AlS is “192.168.252.253”. Similarly, a network address of a network between the load balancing apparatus B16 and the router 14 is “192.168.251/24”. A host address of an interface on the router 14 side of the load balancing apparatus B16 is “253”. The load balancing apparatus A15 sets VLAN (Virtual LAN) on at least the side of the Web servers 17a and 17b. The load balancing apparatus B16, too, sets VLAN (Virtual LAN) on at least the side of the Web servers 17c and 17d. In the VLAN that are respectively set on the sides of the Web servers 17c and 17d and the Web servers 17c and 17d, the load balancing apparatus A15 and B16 set the same virtual IP address (hereinafter called “VIP”), that is, 192.168.100.10 in the embodiment shown in the drawing. Therefore, the Web servers 17a to 17d are all identified (represented) by the same VIP and are recognized as one Web server by the client terminals and the DNS server. The DNS server 12 associates the VIP with the domain name www.hitachi-datacenter.co.jp.

Incidentally, the network address of each VLAN between the load balancing apparatus A15 and the Web servers 17a and 17b and between the load balancing apparatus B16 and the Web servers 17c and 17d is “192.168.100/24” in FIG. 2. Host addresses “1”, “2”, “3” and “4” are respectively set to the Web servers 17a, 17b, 17c and 17d. Therefore, the load balancing apparatus A15 identifies the Web server 17a by the IP address “192.168.100.1” and the Web server 17b by the IP address “192.168.100.2”. Similarly, the load balancing apparatus B16 identifies the Web server 17c by the IP address “192.168.100.1” and the Web server 17d by the IP address “192.168.100.2”.

A host address of the interface of the router 14 on the client terminal side, a host address of the interface on the DNS server 12 side, a host address of the interface on the side of the load balancing apparatus A15 and a host address of the interface on the side of the load balancing apparatus B16 are all “254”. A network address of the network between the router 14 and the DNS server 12 is “192.168.254/24” and a network address of the network between the router 14 and the client terminal 11 is “192.168.250/24”. A host address of each client terminal 11 is “1” and “2”.

An operation example of each apparatus shown in FIG. 2 will be explained.

To begin with, a user using the client terminal 11 desires to gain access to the site 10 and inputs the domain name www.hltachi-datacenter.co.jp of the site 10 to the client terminal 11. The client terminal 11 inquires the DNS server 12 of the IP address corresponding to this domain name. The DNS server 12 holds the domain name of the site in association with VIP “192.168.100.10” as described above and notifies the client terminal 11 of this VIP. The client terminal 11 issues an access to the Web servers 17a to 17d of the site 10 by using VIP so notified as a destination address. The router 14 of the site 10 receives this access through the Internet. Due to the function described above, the router 14 recognizes that two routes exist for the access to the destination (or two load balancing apparatuses for transferring the access exist). The router 14 calculates the hash value from the information of the destination address (VIP) and the transmitting address (IP address of the client terminal) contained in the access received in accordance with a hash function that is determined in advance. Since the router 14 has in advance a table for associating the load balancing apparatus (route) to which the access is to be transferred with each hash value, the router 14 looks up the table and decides the load balancing apparatus (route) to which the access received is to be transferred. The router 14 transfers the access to the load balancing apparatus so decided, for example, the load balancing apparatus A15. The router 14 executes this processing whenever it receives the access to the Web servers 17a to 17d and transfers the access to each load balancing apparatus A15 or B16. The load balancing apparatus A15 or B16 receives the access and recognizes that this access is addressed to the Web servers 17a to 17d. The load balancing apparatus A15 or B16 transfers the access to the two Web servers connected to each load balancing apparatus by round robin scheduling. Therefore, the Web servers 17a and 17b connected to the load balancing apparatus A15, for example, alternately receive the access. This also holds true of the Web servers 17c and 17d connected to the load balancing apparatus B16.

In this way, the router 14 allocates the access issued from the client terminal 11 to the two load balancing apparatus A15 and B16, and each load balancing apparatus A15, B16 allocates the access to the two Web servers 17a and 17b or 17c and 17d.

Because setting of the address, or the like, is made to each constituent apparatus of the network system of the site 10 as described above, the router 14 and each load balancing apparatus A15, B16 allocate the access. Therefore, the access can be distributed substantially uniformly to a plurality of Web servers inside the system.

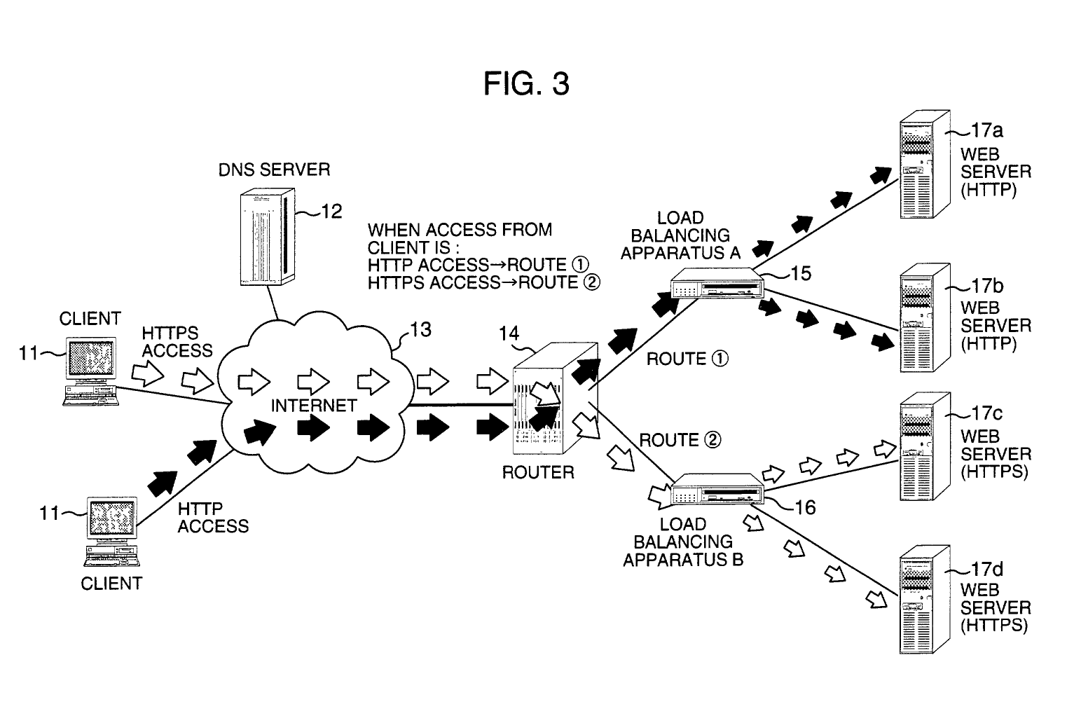

FIG. 3 shows another structural example of the network system. Reference numerals used in FIG. 3 are the same as those used in FIG. 1.

The system construction shown in FIG. 3 is the same as that of FIG. 1. The router in the network system shown in FIG. 1 has the function of distributing and transferring the access to the same destination to two or more different routes. In the network system shown in FIG. 3, on the other hand, the router has a policy routing function, and distributes and transfers the access by this function. Originally, the router selects an optimal route of the network on the basis of the destination address of the IP packet and forwards the packet. On the other hand, the policy routing function represents a function of the router for selecting the forward route on the basis of information other than the destination address of the packet, such as a port number of the TCP port, that is, the kind of an application.

Therefore, the router 14 decides the selected route on the basis of the kind of the access issued from the client terminal 11 (the kind of the application used). For this reason, the Web servers disposed inside the site 10, too, are so grouped as to correspond to the access kind.

For example, the access issued from the client terminal 11 includes an ordinary HTTP (Hyper Text Transfer Protocol) access and an HTTPS access generated by ciphering the ordinary HTTP access by using an SSL (Security Sockets Layer) to exchange information calling for security. FIG. 3 shows the mode in which these two kinds of accesses are issued from the client terminal 11.

The Web servers 17a and 17b among the WEB servers 17a to 17d are so set as to process the HTTP access and the Web servers 17c and 17d are so set as to process the HTTPS access. The Web servers 17c and 17d receive the access from the load balancing apparatus B16 and the Web servers 17a and 17b receive the access from the load balancing apparatus A15.

The client terminal 11 issues the HTTP access when the user desires to check the information provided by the site 10, for example. When the user desires to purchase the goods provided by the site 10 and to transmit information calling for security such as a credit card number, the client terminal issues the HTTPS access. Various kinds of information (conditions) for policy routing are set in advance to the router 14. The information contains a plurality of access kinds and routes (apparatus to which the access is to be transferred) corresponding to the access kinds. For example, the HTTP access and the route 1) (load balancing apparatus A15) are associated with each other and are set to the router 14. Similarly, the HTTPS access and the route 2) are associated with each other and are set to the router 14. The route 1) is the route for forwarding the access to the Web server 17a or 17b through the load balancing apparatus A15. The route 2) is the route for forwarding the access to the Web server 17c or 17d through the load balancing apparatus B165. The information is registered to a table held by the router 14, for example. Receiving the access from the client terminal 11, the router 14 looks up the information about the application contained in the access such as a port number of the TCP port and recognizes the kind of the access. In the embodiment shown in FIG. 3, the router 14 recognizes whether the access it receives is the HTTP access or the HTTPS access. The router 14 selects the route 1) in accordance with a set condition when the access is the HTTP access and selects the route 2) when the access is the HTTPS access. In consequence, the router 14 forwards the HTTP access to the load balancing device and the HTTPS access to the load balancing apparatus B16.

As described above, each load balancing apparatus A15, B16 receives the access and transfers the access to two Web servers connected thereto by round robin scheduling.

Consequently, the router 14 allocates the access issued from the client terminal 11 in accordance with its kind to the two load balancing apparatus A15 and B16. Further, each load balancing apparatus A15, B16 allocates the access to the two Web servers 17a, 17b or 17c, 17d.

Incidentally, the address of each apparatus in the network system shown in FIG. 3 may well be the same as the address shown in FIG. 2.

The frequency (proportion) of issuance of the different kinds of accesses issued from the client terminal is mutually different. Therefore, the proportion of the number of sets of the Web servers for processing the respective kind of accesses is changed in accordance with the issuance frequency of various kinds of accesses. When the issuance ratio of the HTTP access to the HTTPS access is 3:1, for example, the number of sets of the Web servers for processing the HTTP access is 3 and the number of sets of the Web servers for processing the HTTPS access is 1. In this case, the Web servers 17a to 17c are connected to the load balancing device A15 and the Web server 17d is connected to the load balancing apparatus B16. Since the site 10 is constituted in this way, it becomes possible to constitute a system in which an access can be more uniformly distributed to a plurality of Web servers.

As described above, the route is decided for each kind of the access. Therefore, the output interface of the router 14 can be fixedly allocated to each kind of access issued from the client terminal. In this case, the router 14 transmits each kind of access from the output interface decided for each kind.

In the network system shown in FIGS. 1 to 3, the router 14 and the load balancing apparatus A15 and B16 hierachically distribute the load. Generally, the router can forward (process) at a high speed an access. On the other hand, the transfer rate (processing speed) of the load balancing apparatus is lower (slower) than that of the router. Therefore, when the router 14 forwards the access to a specific load balancing appliance without distributing it, for example, the transfer rate of the access to the load balancing apparatus may be higher than the access processing speed by the load balancing apparatus. In such a case, the accesses stay in the load balancing apparatus. In other words, the load balancing apparatus becomes a bottleneck. On the other hand, when the router 14 distributes and forwards the access to two or more load balancing apparatus, the access forwarded to each load balancing apparatus is not greater than ½ of the access processed by the router 14. Consequently, even when the line speed on the input side (client terminal side) of the router 14 is extremely high such as dozens of Gb/sec, the router 14 distributes the access sent through the line to each load balancing apparatus and the access does not stay inside one load balancing apparatus. The amount of the accesses processed in a certain unit time by all the load balancing apparatus is naturally greater than the amount of the accesses processed by one load balancing apparatus. Therefore, the site 10 can more efficiently process the accesses and can cope with a higher-speed input line.

In the network system described above, the router and the load balancing apparatus distribute the load in two stages. However, the network system may well be constituted by routers and load balancing apparatus respectively connected in multiple stages. In this case, because the routers and the load balancing apparatus hierachically connected distribute the load, load balancing is conducted in multiple stages. It is possible, for example, to distribute the load in three stages by the routers connected in two stages and the load balancing apparatus in one stage.

Incidentally, the router 14, the load balancing apparatus 15 and 16 and the Web server 17 constituting the network system of the site 10 may be installed in the same place such as in the same building or in a specific area, or may be respectively installed in mutually different places such as in different areas or at remote points. Various communication lines connect these constituent apparatus to one another.

Therefore, it is possible to arrange a plurality of Web servers of the site 10 in geographically remote places. Even when a disaster occurs in a specific area, the site 10 can keep the operation by utilizing the Web servers and other apparatuses installed in other areas and reliability of the site can be improved.

In the network described above, the 32-bit IP address is set to each apparatus as shown in FIG. 2. In other words, this network employs IPv4 (Internet Protocol version 4) as the communication protocol. However, this network can also employ IPv6 (Internet Protocol version 6) as the communication protocol.

The merits acquired when the network employs IPv6 will be explained.

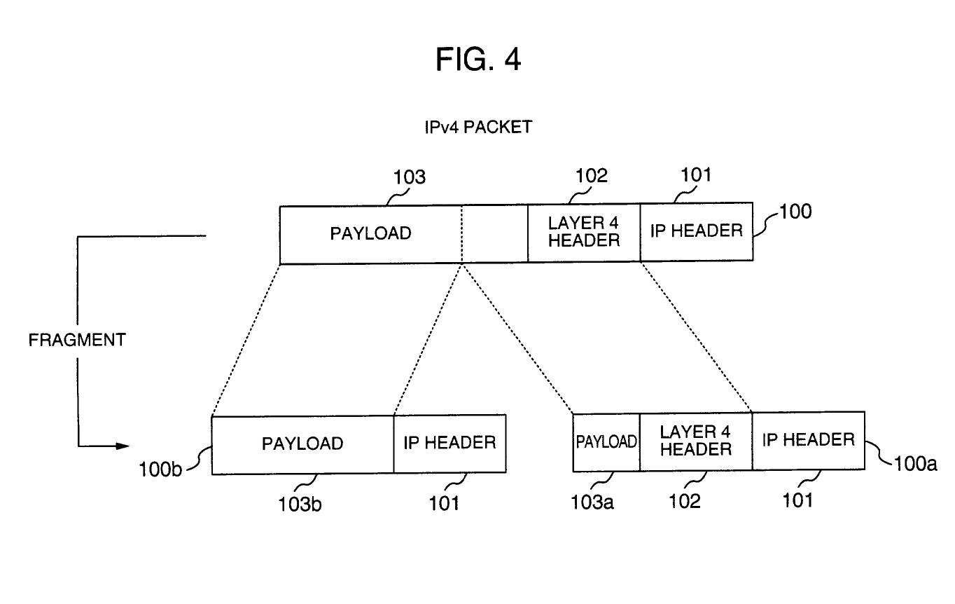

The specification of IPv4 permits a router existing in a line to fragment a packet. FIG. 4 shows a mode in which the IPv4 packet is fragmented. The IPv4 packet 100 includes an IP header 101, a layer 4 header such as a TCP header and a payload (data) 103 as shown in the drawing. When the router fragments this IPv4 packet 100, the IPv4 packet is fragmented into two or more IPv4 packets. In FIG. 2, the IPv4 packet 100 is shown fragmented into two IPv4 packets 100a and 100b. In this case, the router regards the layer 4 header 102 and the payload 103 as one payload (data) by putting them together, and fragments it into two or more payloads. The first payload among the payloads so fragmented contains the layer 4 header 102 and a part of the payload 103 fragmented into two or more payloads. The first IPv4 packet 100a among the IPv4 packets fragmented by the router contains the first payload. Therefore, the IPv4 packet 100a includes the IP header 101, the layer header 102 and the payload 103a as shown in FIG. 4.

On the other hand, the second IPv4 packet 100b et seq. contains only one of the payloads 103 fragmented. Therefore, the IPv4 packet 100b includes the IP header 101 and the payload 103b. The layer 4 header is not included in the IPv4 packet 100b.

When the router 14 of the site 10 distributes a plurality of IPv4 packets so fragmented to the load balancing devices by using the policy routing function, the following problems may occur.

It will be assumed, for example, that the router 14 receives the first IPv4 packet 100a of the IPv4 packets fragmented. The router 14 analyzes the port number of the TCP port of the layer 4 header 102 contained in the IPv4 packet 100a, for example. The router 14 then recognizes from this port number that the packet corresponds to the HTTP address, for example, and forwards it to the load balancing apparatus 15. Next, it will be assumed that the router 14 receives the second IPv4 packet et seg of the IPv4 packets fragmented. The router 14 likewise attempts to analyze the content of the layer 4 header but cannot correctly analyze it because the IPv4 packet 100 does not contain the layer 4 header. Therefore, there is the possibility that the router 14 fails to correctly forward this packet.

In contrast, the specification of IPv6 inhibits fragmentation by a router existing in a line. Generally, a terminal corresponding to IPv6 knows in advance a maximum packet length that can be transmitted, and the specification inhibits fragmentation in the line. Therefore, the problems that might occur during the forward of the IPv4 packet described above do not occur in the forward of the IPv6 packet. In other words, in the network employing IPv6, the router can more flexibly distribute the load.

As explained above, the router inside the site allocates the access sent from the client terminal to a plurality of load balancing apparatus and the load to the individual load balancing devices can be reduced. When any fault occurs in the route to one load balancing apparatus, the router can quickly switch the route to another route.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A network system comprising:
a plurality of servers;
a plurality of load balancing apparatus, each of said load balancing apparatus being connected to two or more of said plurality of servers, receiving an access packet to said plurality of servers and transferring said access packet received to an arbitrary server among said two or more servers connected thereto; and
at least one routing apparatus connected respectively to said two or more load balancing apparatus among said plurality of load balancing apparatus, and connected to a network, said routing apparatus receiving an access packet to said plurality of servers from said network and forwarding said access packet received to an arbitrary load balancing apparatus among said two or more load balancing apparatus connected thereto.

2. A network system according to claim 1, wherein each of said load balancing apparatus serially transfers said access packet it receives to each of said two or more servers.

3. A network system according to claim 1, wherein said routing apparatus stores in advance an arbitrary hash value in association with each of said two or more load balancing apparatus, calculates the hash value by using address information contained in said access packet it receives, and selects said load balancing apparatus associated with the hash value.

4. A network system according to claim 1, wherein said routing apparatus stores in advance an access kind in association with each of said two or more load balancing apparatus, judges the access kind from header information contained in said access packet it receives, and selects said load balancing apparatus associated with the access kind.

5. A network system according to claim 1, wherein the same address is set to said plurality of servers, and said routing apparatus receives a plurality of access packets containing said address as a destination address from said network, and distributes and forwards said plurality of access packets to said two or more load balancing apparatus.

6. A network system according to claim 1, wherein each of said load balancing apparatus has a function of setting VLAN to at least said server connected thereto, and said routing apparatus receives a plurality of access packets containing said address as a destination address from said network, and distributes and forwards said plurality of access packets to said two or more load balancing apparatus.

7. A network system according to claim 3, wherein said routing apparatus calculates a hash value by using a destination address and a source address contained in said access packet.

8. A network system according to claim 4, wherein said routing apparatus judges the access kind from a port number of a TCP port of header information contained in said access packet.

9. A network system according to claim 4, wherein said plurality of servers contain two or more servers for processing either one kind of access and two or more servers for processing the other one kind of access, each of said load balancing apparatus is connected to said two or more servers for processing the same kind of accesses, and said routing apparatus stores a kind of access in association with said load balancing apparatus to which said servers for processing said kind of access are connected.

10. A method of distributing a plurality of access packets received from a network to a plurality of servers in a network system, said network system including a plurality of servers, a plurality of load balancing apparatus respectively connected to two or more servers among said plurality of servers and at least one routing apparatus connected to said two or more load balancing apparatus of said plurality of load balancing apparatus and to said network, said method comprising the steps of:
receiving from said network a plurality of access packets containing an address set in common for said plurality of servers as a destination address by said routing apparatus;
selecting in each of said routing apparatus a load balancing device to be forwarded from among said two or more load balancing apparatus for each of said access packets received, forwarding each of said access packets, and distributing and forwarding said plurality of access packets to said two or more load balancing apparatus;
receiving each of said access packets by each of said load balancing apparatus; and
selecting an arbitrary server from among said two or more servers for each of said access packets received by each of said load balancing apparatus, and transferring said access packet to distribute and transfer said plurality of access packets to said two or more servers.

11. A distributing method according to claim 10, wherein said step of selecting said server by each of said load balancing apparatus serially selects said two or more servers.

12. A distributing method according to claim 10, wherein said step of selecting said load balancing apparatus by each of said routing apparatus associates in advance an arbitrary hash value with each of said two or more load balancing apparatus by each of said routing apparatus, calculates the hash value by using address information contained in each of said access packets, and selects said load balancing apparatus associated with the hash value.

13. A distributing method according to claim 10, wherein said step of selecting said load balancing apparatus by each of said routing apparatus associates in advance a kind of access with each of said two or more load balancing apparatus by each of said routing apparatus, judges the kind of access from header information contained in each of said access packets and selects said load balancing apparatus associated with the kind of access.

14. A distributing method according to claim 10, which further comprises the step of setting VLAN on the server side by each of said load balancing apparatus, and setting the same address to said respective VLAN to set the same address to said plurality of servers.

15. A method of processing an access request packet in an information service site, said information service site including a plurality of servers, a plurality of load balancing apparatus respectively connected to two more of said plurality of servers, and at least one routing apparatus connected to said two or more load balancing apparatus among said plurality of load balancing apparatus and to a network, for receiving access request packets transmitted from a plurality of client devices through said network and providing services to said plurality of client devices, said processing method comprising the steps of:
setting the same address for said plurality of servers;
receiving a plurality of access request packets containing said address as a destination address from said network by said routing apparatus;
selecting said load balancing apparatus to be forwarded from said two or more load balancing apparatus for each of said access request packets so received, and forwarding each of said access request packets by said routing apparatus;
receiving each of said access request packets by each of said load balancing apparatus;
selecting an arbitrary server from said two or more servers for each access request packet so received by each of said load balancing apparatus, and transferring said access request packet; and
receiving and processing each of said access request packet by each of said servers.

16. A processing method according to claim 15, wherein said step of selecting said servers in each of said load balancing apparatus serially selects said two or more servers.

17. A processing method according to claim 15, wherein said step of selecting said load balancing apparatus by each of said load balancing apparatus associates in advance an arbitrary hash value with each of said two or more load balancing apparatus in each of said routing apparatus, calculates the hash value by using address information contained in each of said access request packets and selects said load balancing apparatus associated with the hash value.

18. A processing method according to claim 15, wherein said step of selecting said servers in each of said load balancing apparatus associates in advance an access kind with each of said two or more load balancing apparatus, judges the access kind from header information contained in each of said access request packets, and selects said load balancing apparatus associated with the access kind.

19. A processing method according to claim 15, wherein said step of setting the same address for said plurality of servers sets VLAN on the server side by each of said load balancing apparatus, and sets the same address to each of said VLAN.
